(19) United States
(12) Patent Application Publication
(10) Pub. No.: US 2026/0364409 A1
(43) Pub. Date: Nov. 19, 2026

(54) GOLF BALL POLYURETHANE COVER FORMULATIONS WITH REDUCED MATERIAL HARDNESS AND IMPROVED PROCESSABILITY

(71) Applicant: Acushnet Company, Fairhaven, MA (US)

(72) Inventors: Shawn Ricci, New Bedford, MA (US); Michael Michalewich, Norton, MA (US)

(73) Assignee: Acushnet Company, Fairhaven, MA (US)

(21) Appl. No.: 19/207,807

(22) Filed: May 14, 2025

(51) Int. Cl. A63B 37/00; C08G 18/75

(52) U.S. Cl. CPC A63B 37/0023; A63B 37/0074; A63B 37/0096; C08G 18/752

(57) ABSTRACT

Golf balls including a core and a cover disposed on the core. The cover may be formed from a cover composition. The cover composition may include a first isocyanate-containing component, a second isocyanate-containing component, an isocyanate-reactive component, and a chain extender. The first isocyanate-containing component may be isophorone diisocyanate. The second isocyanate-reactive component may be an aliphatic isocyanate-containing component such as 1,6-hexamethylene diisocyanate (HDI) uretdione and HDI isocyanurate. The ratio of the first isocyanate-containing component to the second isocyanate-containing component ranges from about 60:40 to about 80:20. The ratio of the first and second isocyanate-containing components to the isocyanate-reactive component is about 1:0.95 to about 1.2:1. The chain extender may be a hydroxy-terminated chain extender or an amino-terminated chain extender.

### FIELD OF THE INVENTION

The present disclosure relates generally to polyurethane and hybrid polyurethane-polyurea compositions, methods of making such compositions, and golf balls including at least one layer formed from such compositions. The compositions of the present disclosure result in golf ball components with improved physical properties such as reduced hardness and increased shear durability as well as improved processability during manufacturing. A golf ball made in accordance with the present disclosure may include a golf ball component formed from a composition of the present disclosure. For example, in one embodiment, a golf ball formed in accordance with the present disclosure may include a core surrounded by a cover formed from a polyurethane or hybrid polyurethane-polyurea composition of the present disclosure. In this aspect, a golf ball made in accordance with the present disclosure may have many advantageous physical and playing performance properties.

### BACKGROUND OF THE INVENTION

Modern multi-piece, solid golf balls often include a core, a casing layer disposed around the core, and a cover layer disposed around the casing layer. As a result of the favorable properties, polyurethanes and polyureas are employed as structural and coating layers for such golf balls. In particular, cover layers are commonly cast from polyurethanes, polyureas, or polyurethane-polyurea or polyurea-polyurethane hybrids. For example, popular three-piece golf balls may include a rubber core surrounded by an ionomer-based casing layer and a cover layer formed from a polyurethane or polyurethane-polyurea hybrid.

Whether used for structural layers or coating layers, polyurethanes, polyureas, and polyurethane-polyurea or polyurea-polyurethane hybrids used in golf ball manufacturing are generally formed by the reaction between an isocyanate-containing component, which may be a multi-functional isocyanate, and an isocyanate-reactive component, which may be a long-chain polyol or polyamine. In general, polyurethanes are produced by the reaction of a multi-functional isocyanate (NCO—R—NCO) with a long-chain polyol having terminal hydroxy groups (OH—R′—OH) in the presence of a catalyst and other additives to form a polyurethane prepolymer. The chain length of the polyurethane prepolymer may be extended by reacting it with a curative blend including chain extenders that may be short-chain diols (OH—R″—OH) to form a polyurethane or short-chain diamines (NH₂—R″—NH₂) to form a polyurethane-polyurea hybrid. Similarly, polyureas are produced by the reaction of a multi-functional isocyanate (NCO—R—NCO) with a long-chain polyamine having terminal amino groups (NH₂—R′—NH₂) in the presence of a catalyst and other additives to form a polyurea prepolymer. The chain length of the polyurea prepolymer may be extended by reacting it with a curative blend including chain extenders that are short-chain diamines (NH₂—R′—NH₂) to form a polyurea or with short-chain diols (OH—R′—OH) to form a polyurea-polyurethane hybrid.

The resulting polyurethane, polyurea, or polyurethane-polyurea or polyurea-polyurethane hybrids has elastomeric properties. The elastomeric properties of the resulting polyurethane, polyurea, or polyurethane-polyurea or polyurea-polyurethane hybrid can be altered by modifying the type or amount of the isocyanate-containing component or isocyanate reactive component in the prepolymer or the chain extenders in the curative blend. The elastomeric properties of the polyurethane, polyurea, or polyurethane-polyurea or polyurea-polyurethane hybrid affect the performance characteristics of the golf ball including a cover formed from the polyurethane, polyurea, or polyurethane-polyurea or polyurea-polyurethane hybrid.

In this aspect, the spin rate and feel of the ball are important performance characteristics that are affected by the composition and construction of the cover. The spin rate refers to the rate of rotation of the golf ball after being struck by a club. One factor that affects the spin rate of a golf ball is the hardness of the cover. Generally, increasing the hardness of the cover decreases the spin rate of the golf ball when struck by a golf club as the hard golf ball cover “grips” the golf club less and, in turn, less spin is imputed from the golf club onto the golf ball. In contrast decreasing the hardness of the cover of a golf ball increases the spin rate as the softer golf ball cover “grips” the golf club more and, in turn, more spin is imputed from the golf club to the golf ball.

Most professionals and highly skilled amateurs (i.e., those who can control the spin of a golf ball) generally prefer balls with high spin rates to allow for better control in and around the green and draw and fade on approach shots. Indeed, these balls are beneficial for short distance shots made with irons and wedges. In contrast, recreational players who cannot necessarily control the spin of the ball will likely find that it is easier to play with a golf ball with low spin because the spin from a golf ball with a high spin rate can create more shot dispersion, i.e., more stray off to the left or right of the centerline, especially if the ball is hooked or sliced.

Meanwhile, the “feel” of the ball generally refers to the sensation that a player experiences when striking the ball with the club. Most players prefer balls having a soft feel, because the players experience a more natural and comfortable sensation when the club face makes contact with these balls. Balls having a softer feel are particularly desirable when making short shots around the green, because the player senses more with such balls. The feel of the golf ball depends upon the hardness of the cover on the golf ball among other things.

Over the past several years, golf ball cover hardness has trended lower to meet golfers demands. Traditionally, manufacturers have reduced the hardness of golf ball covers made from polyurethane, polyurea, or polyurethane-polyurea or polyurea-polyurethane hybrids by decreasing isocyanate content within the prepolymer used to form the cover. Although this has been successful in the past, manufacturers are reaching the point where the isocyanate content in the prepolymer cannot be decreased further without increased difficulty in manufacturing. Particularly, further reduction in the isocyanate content of the prepolymer would increase the viscosity of the prepolymer to the extent that it would be prohibitive to synthesizing the prepolymer. Further reduction in the isocyanate content of the prepolymer would also reduce the reactivity of the prepolymer with the curative blend. In turn, low reactivity between the prepolymer and the curative blend results in increased manufacturing complexity as it may require post cure ovens and unconventional mold assembly times and result in costly delays. Additionally, low reactivity between the prepolymer and the curative blend increases the frequency of blemishes forming in the golf ball and increases the difficulty of concentrically placing the golf ball core within the cover. Such blemishes or lack of concentricity of the golf ball components may result in performance inadequacies and can affect shot dispersion.

Thus, it would be advantageous to have compositions for use in the cover layers of golf balls that decrease hardness and improve processability of the golf ball without the need for additional manufacturing steps. The present disclosure provides such compositions and golf balls including components made with such compositions.

### SUMMARY OF THE INVENTION

In some embodiments, the present disclosure relates to a golf ball including a core and a cover disposed on the core and formed from a cover composition that is the reaction product of a first isocyanate-containing component including isophorone diisocyanate, a second isocyanate-containing component having a molecular weight that is about 200 to about 600 g/mol, an isocyanate-reactive component, and a chain extender. In another embodiment, the second isocyanate-containing component is aliphatic. In yet another embodiment, the second isocyanate-containing component includes 1,6-hexamethylene diisocyanate (HDI). In still another embodiment, the second isocyanate-containing component includes HDI uretdione and/or HDI isocyanurate.

In a further embodiment, the ratio of the first isocyanate-containing component to the second isocyanate-containing component ranges from about 50:50 to about 90:10. In another embodiment, the ratio of the first isocyanate-containing component to the second isocyanate-containing component ranges from about 60:40 to about 80:20. In yet another embodiment, the isocyanate-reactive component includes polyether polyol. In still another embodiment, the isocyanate-reactive component includes polytetramethylene ether glycol. In another embodiment, the chain extender is a hydroxy-terminated chain extender. In yet another embodiment, the chain extender is an amino-terminated chain extender. In still another embodiment, the ratio of the first and second isocyanate-containing components to the isocyanate-reactive component is about 1:0.95 to about 1.2:1.

In some embodiments, the present disclosure provides a golf ball including a core and a cover disposed on the core and formed from a cover composition that is the reaction product of a first isocyanate-containing component including isophorone diisocyanate, a second isocyanate-containing component including 1,6-hexamethylene diisocyanate (HDI), an isocyanate-reactive component, and a chain extender, wherein the ratio of the first isocyanate-containing component to the second isocyanate-containing component ranges from about 50:50 to about 90:10. In another embodiment, the ratio of the first isocyanate-containing component to the second isocyanate-containing component ranges from about 60:40 to about 80:20. In yet another embodiment, the second isocyanate-containing component includes HDI uretdione and/or HDI isocyanurate. In still another embodiment, the ratio of the first and second isocyanate-containing components to the isocyanate-reactive component is about 1:0.95 to about 1.2:1.

In some embodiments, the present disclosure provides a golf ball including a core and a cover disposed on the core and formed from a prepolymer and a chain extender, wherein the prepolymer includes the reaction product of a first isocyanate-containing component having a first molecular weight FICC_{MW}, a second isocyanate-containing component having a second molecular weight SICC_{MW}, and an isocyanate-reactive component, wherein after the reaction of the first isocyanate-containing component, the second isocyanate containing component, and the isocyanate reactive component, the prepolymer has a percentage of unreacted NCO groups NCO_{Unreacted}, and wherein

$$1.3 \leq \frac{{FICC}_{M W} / {SICC}_{M W}}{N C {O}_{U n r e a c t e d}} \leq 100 .$$

In another embodiment,

$$5. < \frac{{FICC}_{M W} / {SICC}_{M W}}{N C {O}_{U n r e a c t e d}} < 27.0 .$$

In yet another embodiment,

$$10. < \frac{{FICC}_{M W} / {SICC}_{M W}}{N C {O}_{U n r e a c t e d}} < 14.0 .$$

In a further embodiment, NCO_{Unreacted} is equal to about 1% to about 8% based on the total weight of the prepolymer. In another embodiment, NCO_{Unreacted} is equal to about 5% to about 6% based on the total weight of the prepolymer.

### BRIEF DESCRIPTION OF THE DRAWINGS

Further features and advantages of the present disclosure can be ascertained from the following detailed description that is provided in connection with the drawings described below:

FIG. 1 is a cross-sectional view of a three-piece golf ball assemblage in accordance with an embodiment of the present disclosure;

FIG. 2 is a cross-sectional view of a four-piece golf ball in accordance with an embodiment of the present disclosure;

FIG. 3 is a cross-sectional view of a five-piece golf ball in accordance with an embodiment of the present disclosure;

FIG. 4 is a graph showing the measured viscosity build over time of a golf ball cover formed from a cover composition in accordance with the present disclosure as well as golf ball covers formed from conventional cover compositions; and

FIG. 5 is a graph showing the measured color change of a golf ball cover formed from a cover composition in accordance with the present disclosure relative to a control golf ball cover as well as the measured color change of a golf ball cover formed from conventional cover compositions relative to the same control golf ball cover.

### DETAILED DESCRIPTION OF THE INVENTION

The present disclosure relates to compositions that may be used to produce golf ball components. In some embodiments, the compositions of the present disclosure may be used to form a cover layer of a golf ball. The compositions described herein may result in golf ball cover layers with decreased hardness and improved processability (as compared to golf balls that do not include the components formed from compositions of the present disclosure). The compositions and the components and golf balls formed therefrom are discussed in more detail below.

### Compositions

The compositions of the present disclosure may include a base polymer and one or more other components. Concentrations of components are in weight percent (wt %) unless otherwise indicated. As used herein, the term, “weight percent,” also known as “percent by weight” or “wt %” is defined as the weight of a particular component present in a mixture, relative to the weight of the mixture as a whole. Mathematically, this can be expressed as the weight of an ingredient divided by the total weight of the mixture, multiplied by a factor of 100.

The base polymer may include organic units joined by linkages formed by reacting an isocyanate-containing component having an isocyanate group (—N═C═O or —NCO) with an isocyanate-reactive component having terminal nucleophilic functional groups, such as a hydroxy group (—OH) or an amino group (—NH₂). The reaction between the isocyanate group (—N═C═O) of the isocyanate-containing component and the nucleophilic functional group of the isocyanate-reactive component results in at least one of the following linkages:

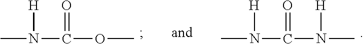

The urethane linkage (—NHCOO—) results from the reaction of an isocyanate-containing component and a hydroxy-terminated isocyanate-reactive component. The urea linkage (—HNCONH—) results from the reaction of an isocyanate-containing component and an amino-terminated isocyanate-reactive component. The base polymer of the present disclosure includes multi-disperse blocks of soft and hard segments in an alternative fashion as shown below in (I):

—(X—Y)—ₙ (I)

where X represents the soft segment—formed from the isocyanate-reactive component discussed below—and Y represents the hard segment—formed from the isocyanate-containing component and a chain extender that extends the chain length of the polymer and builds up its molecular weight. The soft segments provide elasticity, toughness, and resiliency, while the hard segments contribute strength, hardness, and elevated temperature performance. In other words, the hard segments provide a physical, stable network formed by chemical or hydrogen bonds or result from chain entanglement and the soft segments provide the rubbery deformability through a temporary network formed by crystalline, semi-crystalline or liquid crystalline, or amorphous domains.

The base polymer may be produced by the reaction of a multi-functional isocyanate (NCO—R—NCO) with a long-chain isocyanate-reactive component, such as a long-chain polyol (OH—R′—OH) or polyamine (NH₂—R′—NH₂). For example, the base polymer of the cover may be formed from a polyurethane, polyurea, or polyurethane-polyurea or polyurea-polyurethane hybrid depending on the desired characteristics and performance of a golf ball having a cover including the base polymer.

A polyurethane or polyurethane-polyurea composition used to form the outer cover layer includes urethane linkages formed by reacting an isocyanate group (—N═C═O) with a hydroxy group (—OH). The polyurethane or polyurethane-polyurea composition may be produced by the reaction of an isocyanate-containing component and a hydroxy-terminated component. In some embodiments, the polyurethane or polyurethane-polyurea composition is produced by the reaction of a multi-functional isocyanate compound (NCO—R—NCO) with a long-chain polyol having terminal hydroxy groups (OH—R′—OH) to form a polyurethane prepolymer in the presence of a catalyst and other additives. By the term, “prepolymer” as used herein, it is meant a polymer of relatively low to medium molecular weight that is normally the intermediate material between a monomer and final polymer, and which may be further polymerized by reacting with cross-linking agents or chain extenders. To form a polyurethane composition, the chain length of the polyurethane prepolymer is extended by reacting it with short-chain diols (OH—R″—OH). To form a hybrid polyurethane-polyurea composition, the chain length of the polyurethane prepolymer is extended by reacting it with short-chain diamines (NH₂—R″—NH₂).

Similarly, a polyurea or polyurea-polyurethane composition used to form the outer cover layer includes urea linkages formed by reacting an isocyanate group (—N═C═O) with an amino group (—NH₂). The polyurea composition may be produced by the reaction of an isocyanate-containing component and an amino-terminated component. In some embodiments, the polyurea or polyurea-polyurethane composition is produced by the reaction of a multi-functional isocyanate compound (NCO—R—NCO) with a long-chain polyamine having terminal amino groups (NH₂—R′—NH₂) to form a polyurea prepolymer in the presence of a catalyst and other additives. To form a polyurea composition, the chain length of the polyurea prepolymer is extended by reacting it with short-chain diamines (NH₂—R″—NH₂). To form a hybrid polyurea-polyurethane composition, the chain length of the polyurea prepolymer is extended by reacting it with short-chain diols (OH—R″—OH).

### Isocyanate-Containing Component

The term “isocyanate-containing component” refers to any aliphatic or aromatic isocyanate having two or more isocyanate functional groups. The isocyanate-containing component can be monomers or monomeric units because they can be polymerized to produce polymeric isocyanates containing two or more monomeric isocyanate repeating units. The isocyanate-containing component may have any suitable backbone chain structure including saturated or unsaturated, and linear, branched, or cyclic. For example, suitable isocyanate-containing components include diisocyanates having the generic structure: O═C═N—R—N═C═O, where R is preferably a cyclic or linear or branched hydrocarbon moiety containing from about 1 to 20 carbon atoms. The isocyanate-containing component may be a single isocyanate-containing component or a blend of isocyanate-containing components. The term “isocyanate compound” may be used interchangeably with isocyanate-containing component.

The isocyanate-containing component of the cover composition of the present disclosure is a blend of at least two isocyanate-containing components. For example, the isocyanate-containing component may include a blend of at least two aromatic isocyanates, at least two aliphatic isocyanates, or one or more aromatic isocyanates and one or more aliphatic isocyanates.

Suitable aromatic isocyanate-containing components that may be used in accordance with the present disclosure include, for example, meta-tetramethylxylene diisocyanate (TMXDI), 4,4′-methylene diphenyl diisocyanate (MDI), 2,4′-methylene diphenyl diisocyanate (MDI), 2,4-toluene diisocyanate (TDI), 2,6-toluene diisocyanate (TDI), 3,3′-dimethyl-4,4′-biphenyl diisocyanate (TODI), p-phenylene diisocyanate (PPDI), 1,4-benzene diisocyanate, 1,5-naphthalene diisocyanate (NDI), naphthalene 2,4-diisocyanate (NDI), 4,6-xylene diisocyanate (XDI), and homopolymers and copolymers and blends thereof. Suitable aliphatic isocyanate-containing components that may be used in accordance with the present disclosure include, for example, isophorone diisocyanate (IPDI), 1,6-hexamethylene diisocyanate (HDI), HDI uretdione, HDI isocyanurate, dicyclohexylmethane-4,4′-diisocyanate (“H₁₂MDI”), trans-cyclohexane diisocyanate (CHDI), 1,4-Bis(isocyantomethyl)cyclohexane (H₆XDI), trimethyl hexamethylene diisocyanate (TMDI), dodecane diisocyanate (C₁₂DI), trans-cyclohexane-1,4-diisocyanate, and homopolymers and copolymers and blends thereof. An example of a suitable homopolymer of HDI for use with the present disclosure includes Desmodur® N-3400, which is available from Covestro AG of Leverkusen, Germany and includes HDI uretdione and HDI isocyanurate. An example of a suitable IPDI for use with the present disclosure includes Desmodur® I, which is also available from Covestro AG of Leverkusen, Germany. Other suitable aliphatic isocyanate-containing components from Covestro AG of Leverkusen, Germany include monomeric cycloaliphatic diisocyanate Desmodur® W.

The molecular weight of the isocyanate-containing component may vary, but in some embodiments, the isocyanate-containing component has a molecular weight of about 100 to about 600 g/mol. In other embodiments, the molecular weight of the isocyanate-containing component ranges from about 100 to about 500 g/mol or about 200 to about 600 g/mol or about 100 to about 400 g/mol or about 200 to about 500 g/mol or about 300 to about 600 g/mol. In still other embodiments, the molecular weight of the isocyanate-containing component ranges from about 100 to about 300 g/mol or about 200 to about 400 g/mol or about 300 to about 500 g/mol or about 400 to about 600 g/mol. In yet other embodiments, the molecular weight of the isocyanate-containing component ranges from about 100 to about 200 g/mol or about 150 to about 250 g/mol or about 200 to about 300 g/mol or about 250 to about 350 g/mol or about 300 to about 400 g/mol or about 350 to about 450 g/mol or about 400 to about 500 g/mol or about 450 to about 550 g/mol or about 500 to about 600 g/mol.

In some embodiments, more than one type of isocyanate-containing component may be included in the cover composition, i.e., the cover composition may include a first isocyanate-containing component in a first isocyanate-containing component concentration and a second isocyanate-containing component in a second isocyanate-containing component concentration. In this aspect, the ratio of the first isocyanate-containing component concentration (in percent by weight) to the second isocyanate-containing component concentration (in percent by weight) may be about 50:50 to about 90:10. In some embodiments, the ratio of the first isocyanate-containing component concentration to the second isocyanate-containing component concentration may be about 50:50 to about 80:20 or about 60:40 to about 90:10 or about 50:50 to about 70:30 or about 60:40 to about 80:20 or about 70:30 to about 90:10 or about 50:50 to about 65:35 or about 60:40 to about 75:25 or about 65:35 to about 80:20 or about 75:25 to about 90:10. In some embodiments, the ratio of the first isocyanate-containing component concentration to the second isocyanate-containing component concentration may be about 60:40 to about 70:30 or about 65:35 to about 75:25 or about 70:30 to about 80:20 or about 60:40 to about 65:35 or about 63:37 to about 68:32 or about 66:34 to about 71:29 or about 67:33 to about 72:28 or about 69:31 to about 74:26 or about 72:28 to about 77:23 or about 75:25 to about 80:20.

In this aspect, the first isocyanate-containing component may have a molecular weight of about 100 to about 500 g/mol. In other embodiments, the molecular weight of the isocyanate-containing component ranges from about 100 to about 400 g/mol or about 150 to about 350 g/mol or about 200 to about 300 g/mol or about 200 to about 250 g/mol. The second isocyanate-containing component may have a molecular weight of about 200 to about 600 g/mol or about 200 to about 500 g/mol or about 250 to about 450 g/mol or about 300 to about 400 g/mol or about 300 to about 350 g/mol. In this regard, the ratio of the molecular weight of the first isocyanate-containing component to the molecular weight of the second isocyanate-containing component may range from about 0.2 to about 1.0. In some aspects, the ratio of the molecular weight of the first isocyanate-containing component to the molecular weight of the second isocyanate-containing component may range from about 0.3 to about 0.9 or about 0.4 to about 0.8. In still other aspects, the ratio of the molecular weight of the first isocyanate-containing component to the molecular weight of the second isocyanate-containing component may range from about 0.5 to about 0.8 or about 0.6 to about 0.7. In some aspects, the molecular weight of the first isocyanate-containing component is less than the molecular weight of the second isocyanate-containing component.

In one aspect, the isocyanate-containing component is a blend of a first isocyanate-containing component having a molecular weight of about 180 to about 300 g/mol and a second isocyanate-containing component having a molecular weight of about 250 to about 400 g/mol. For example, the isocyanate-containing component may be a blend of isophorone diisocyanate (IPDI), HDI uretdione, and HDI isocyanurate.

### Isocyanate-Reactive Component

The term “isocyanate-reactive component” refers to any aliphatic or aromatic compound having at least two primary or secondary hydroxy or amino functional groups. In some embodiments, the isocyanate-reactive component has low functionality. Low functionality means that there are two or less functional groups. In other embodiments, the isocyanate-reactive component has high functionality. High functionality means more than two functional groups. Without being bound by any particular theory, the use of low functionality isocyanate-reactive components provides softer compositions, whereas the use of high functionality isocyanate-reactive components results in more rigid compositions. The isocyanate-reactive component may be aliphatic, aromatic, or aliphatic-aromatic. The isocyanate-reactive component may be a single isocyanate-reactive component or a blend of isocyanate-reactive components.

In some embodiments, the isocyanate-reactive component may be a polyol. The polyol may be any aliphatic or aromatic compound containing two or more hydroxy functional groups. The term “polyol” may be used interchangeably with hydroxy-terminated component. Suitable polyols for use in accordance with the present disclosure include, but are not limited to, polyether polyols, polyphenylene ether polyols, polybutadiene polyols, polyester polyols, polycaprolactone polyols, polycarbonate polyols, polyamide polyols, and combinations or copolymers thereof. In any of the embodiments discussed below, the hydrocarbon chain can have saturated or unsaturated bonds, or substituted or unsubstituted aromatic and cyclic groups.

In one embodiment, the polyol includes polyether polyol. Suitable polyether polyols include, but are not limited to, polytetramethylene ether glycol (PTMEG); polyethylene glycol (PEG); polypropylene glycol (PPG); polyethylene propylene glycol; polyoxypropylene glycol; and mixtures thereof. The molecular weight of the polyether polyol may vary, but in some embodiments, the polybutadiene polyol has a molecular weight of about 1000 to about 6000 g/mol. In other embodiments, the molecular weight of the polyether polyol ranges from about 1000 to about 5000 g/mol or about 2000 to about 6000 g/mol or about 1000 to about 4000 g/mol or about 2000 to about 5000 g/mol or about 3000 to about 6000 g/mol. In still other embodiments, the molecular weight of the polyether polyol ranges from about 1000 to about 3000 g/mol or about 2000 to about 4000 g/mol or about 3000 to about 5000 g/mol or about 4000 to about 6000 g/mol. In still other embodiments, the molecular weight of the polyether polyol ranges from about 1000 to about 2000 g/mol or about 1500 to about 2500 g/mol or about 2000 to about 3000 g/mol or about 2500 to about 3500 g/mol or about 3000 to about 4000 g/mol or about 3500 to about 4500 g/mol or about 4000 to about 5000 g/mol or about 4500 to about 5500 g/mol or about 5000 to about 6000 g/mol.

In another embodiment, the polyol is a polyphenylene ether polyol. Suitable examples of commercially available polyol blends containing polyphenylene ether polyols include, but are not limited to, those commercially available under the brand name Noryl®. For example, Noryl® AP2001G (containing poly(2,6-dimethyl-1,4-phenylene ether) diol) is available from SABIC of Riyadh, Saudi Arabia.

In still another embodiment, the polyol includes a polybutadiene polyol. As used herein, the term “polybutadiene polyol” means an oligomer of butadiene terminated at each end with a hydroxy functional group and may include partially/fully hydrogenated derivatives). The polybutadiene polyol may have 1,2-, 1,4-cis, and/or 1,4-trans groups in the backbone. Depending on the synthesis method, the vinyl content and functionality may differ. In some aspects, the polybutadiene polyol may have a 1,2 vinyl content of less than about 50 percent. In other aspects, the polybutadiene polyol may have a 1,2 vinyl content of about 50 percent or more. For example, the 1,2 vinyl content may range about 55 percent to about 70 percent. In one embodiment, the 1,2 vinyl content ranges from about 62 to about 68 percent. In some aspects, the functionality may be less than about 2. In other aspects, the functionality may be about 2 to about 3. For example, the functionality may be about 2.3 to about 2.6. One such commercially available polybutadiene polyol is Krasol® LBH 2000 available from Cray Valley of Grand Junction, CO.

In yet another embodiment, the polyol is a polyester polyol. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. As would be understood by those of ordinary skill in the art, such a polyester polyol may be synthesized from a polycondensation reaction between ethylene/butylene/hexamethylene glycol and adipic acid.

In still a further embodiment, the polyol is a polycaprolactone polyol. Suitable polycaprolactone polyols include, but are not limited to, 1,6-hexanediol-initiated polycaprolactone, diethylene glycol-initiated polycaprolactone, trimethylol propane initiated polycaprolactone, neopentyl glycol initiated polycaprolactone, 1,4-butanediol-initiated polycaprolactone, poly(δ-valerolactone), and mixtures thereof.

In yet another embodiment, the polyol is a polycarbonate polyol. Suitable polycarbonate polyols include, but are not limited to, polyphthalate carbonate; poly(hexamethylene carbonate) glycol; and mixtures thereof.

In another embodiment, the polyol is a polyamide polyol. The polyamide polyol may be synthesized from secondary diamines and chain end functionalized to yield primary or secondary alcohol terminal groups. In addition, a suitable polyamide polyol for use in the cover composition of the present disclosure may be made in accordance with U.S. Patent Publication No. 2008/0223519, the entire disclosure of which is incorporated by reference herein. In this aspect, the polyamide polyol may have the formula:

T-[Z—(C═O)—R₂—(C═O)]ₙ—Z-T

where n is at least 1, each T independently is selected, may be the same or different, and is X—R₁—(C═O), each X is independently selected, may be the same or different and is H or OH, each R₁ is independently selected, may be the same or different, and is a hydrocarbon group having from 2 to 54 carbon atoms, each R₂ is independently selected, may be the same or different, and is a hydrocarbon group having from 2 to 54 carbon atoms, and Z is NLN, where L represents a link between a pair of nitrogen atoms joined by a hydrocarbon link. In some embodiments, L is a hydrocarbon group between the nitrogen atoms. In other embodiments, L may be a cyclical hydrocarbon group into which at least one of the N atoms is incorporated therein, and wherein at least 1 but less than all Z groups includes a polyoxyalkyl group. When the cover compositions of the present disclosure are made with polyamide polyol as the isocyanate-reactive component, the soft segment may include tertiary polyamide fragments.

In some embodiments, the isocyanate-reactive component may be a polyamine. The polyamine may be any aliphatic or aromatic compound containing two or more amino functional groups. The polyamine may be an amino-terminated component with a backbone of polycarbonate, polycaprolactone, polybutadiene, polyamide, or combinations thereof. In this aspect, the amino-terminated components may include, but are not limited to, polycarbonate polyamines, polycaprolactone polyamines, polybutadiene polyamines, polyamide polyamines, polyester polyamines, and combinations or copolymers thereof. The hydrocarbon chain can have saturated or unsaturated bonds and substituted or unsubstituted aromatic and cyclic groups. The term “polyamine” may be used interchangeably with amino-terminated component.

In one embodiment, the amino-terminated component includes a polycarbonate polyamine such as poly(phthalate carbonate) diamine, poly(hexamethylene carbonate) diamine, (bisphenol A)-based polycarbonate diamines, and combinations thereof. In some aspects, the polyamine may be an aromatic polycarbonate polyamine. In other aspects, the polyamine may be an aliphatic polycarbonate polyamine.

In another embodiment, the amino-terminated component includes a polycaprolactone polyamine. Examples of polycaprolactone polyamines for used in the cover composition of the present disclosure include, but are not limited to (alkylene oxide)-initiated polycaprolactone polyamine, (ethylene glycol)-initiated polycaprolactone polyamine, (diethylene glycol)-initiated polycaprolactone polyamine, (propylene glycol)-initiated polycaprolactone polyamine, (dipropylene glycol)-initiated polycaprolactone polyamine, 1,4-butanediol-initiated polycaprolactone polyamine, trimethylolpropane-initiated polycaprolactone polyamine, (neopentyl glycol)-initiated polycaprolactone polyamine, 1,6-hexanediol-initiated polycaprolactone polyamine, (polytetramethylene ether glycol)-initiated polycaprolactone polyamine, and combinations thereof.

In yet another embodiment, the amino-terminated component may be an oligomer of butadiene terminated at each end with an amino group. For example, the amino-terminated component may be polybutadiene polyamine, poly(hydrogenated butadiene) polyamine, or a combination thereof.

In still another embodiment, the amino-terminated component includes a polyamide polyamine. The polyamide polyamine may be synthesized from secondary diamines and chain end functionalized to yield primary or secondary amino terminal groups.

In yet another embodiment, the amino-terminated component includes a polyester polyamine such as poly(ethylene adipate) diamine, poly(butylene adipate) diamine, poly(hexamethylene adipate) diamine, poly(ethylene propylene adipate) diamine, poly(ethylene butylene adipate) diamine, poly(hexamethylene butylene adipate) diamine, (o-phthalate-1,6-hexanediol)-based polyester polyamine, poly(ethylene terephthalate)-based polyester polyamine, and combinations thereof.

Other suitable polyamines for use in accordance with the present disclosure include but are not limited to polyoxypropylene diamines, poly(ethylene oxide capped oxypropylene) ether diamines, triethyleneglycoldiamines, propylene oxide-based triamines, trimethylolpropane-based triamines, glycerin-based triamines, and mixtures thereof. In some embodiments, more than one type of isocyanate-reactive component may be included in the cover composition, i.e., the cover composition may include a first isocyanate-reactive component in a first isocyanate-reactive component concentration and a second isocyanate-reactive component in a second isocyanate-reactive component concentration.

The molecular weight of the isocyanate-reactive component may vary, but in some embodiments, the isocyanate-reactive component has a molecular weight of about 1000 to about 6000 g/mol. In other embodiments, the molecular weight of the isocyanate-reactive component ranges from about 1000 to about 5000 g/mol or about 2000 to about 6000 g/mol or about 1000 to about 4000 g/mol or about 2000 to about 5000 g/mol or about 3000 to about 6000 g/mol. In still other embodiments, the molecular weight of the isocyanate-reactive component ranges from about 1000 to about 3000 g/mol or about 2000 to about 4000 g/mol or about 3000 to about 5000 g/mol or about 4000 to about 6000 g/mol. In yet other embodiments, the molecular weight of the isocyanate-reactive component ranges from about 1000 to about 2000 g/mol or about 1500 to about 2500 g/mol or about 2000 to about 3000 g/mol or about 2500 to about 3500 g/mol or about 3000 to about 4000 g/mol or about 3500 to about 4500 g/mol or about 4000 to about 5000 g/mol or about 4500 to about 5500 g/mol or about 5000 to about 6000 g/mol. In further embodiments, the isocyanate-reactive component has a molecular weight of about 1000 to about 4000 g/mol. In other embodiments, the molecular weight of the isocyanate-reactive component ranges from about 1200 to about 3000 g/mol. In still other embodiments, the molecular weight of the isocyanate-reactive component ranges from about 1200 to about 2500 g/mol. In yet other embodiments, the molecular weight of the isocyanate-reactive component ranges from about 1200 to about 2000 g/mol.

To form the polyurethane or polyurea prepolymer, the isocyanate-reactive component (i.e., either a hydroxy-terminated component or an amino-terminated component, respectively) is reacted with a stoichiometric excess of the isocyanate-containing component. The reaction produces an isocyanate-terminated prepolymer. The resulting isocyanate-terminated prepolymer can be reacted with a curative blend as discussed in more detail below.

### Curative Blend

The curative blend includes a chain extender (curing agent) to extend the chain length of the prepolymer and build up its molecular weight. In general, thermoplastic polyurethane or polyurea compositions are typically formed by reacting the isocyanate blend and chain extender at a 1:1 stoichiometric ratio. Thermoset compositions, on the other hand, are cross-linked polymers and are typically produced from the reaction of the isocyanate blend and chain extender at normally about a 1.05:1 stoichiometric ratio.

The chain extender may have a carbon chain backbone with hydroxy terminal groups, amino terminal groups, or a combination thereof. The backbone may be branched or linear. In some embodiments, the chain extender may have an even number of carbon atoms between the terminal groups. In other embodiments, the chain extender may have an odd number of carbon atoms between the terminal groups. In general, the chain extender has a low molecular weight, i.e., about 500 g/mol or less). In some embodiments, the chain extender has a molecular weight of about 400 g/mol or less. In other embodiments, the chain extender has a molecular weight of about 250 g/mol or less. The chain extender may be a single chain extender or a blend of chain extenders.

Suitable hydroxy-terminated chain extenders may be ethylene glycol; diethylene glycol; polyethylene glycol; propylene glycol; 2-methyl-1,3-propanediol (MPO); 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol (BDO); 2,3-butanediol; 1,6-hexanediol; 2,3-dimethyl-2,3-butanediol; trimethylolpropane (TMP); cyclohexyldimethylol; triisopropanolamine; N,N,N′,N′-tetra-(2-hydroxypropyl)-ethylene diamine; diethylene glycol bis-(aminopropyl) ether; 1,5-pentanediol; 1,6-hexanediol; 1,3-bis-(2-hydroxyethoxy)cyclohexane; 1,4-cyclohexyldimethylol; 1,3-bis-[2-(2-hydroxyethoxy) ethoxy]cyclohexane; 1,3-bis-{2-[2-(2-hydroxyethoxy) ethoxy]ethoxy}cyclohexane; trimethylolpropane; polytetramethylene ether glycol (PTMEG) (preferably having a molecular weight from about 250 to about 500); hydroquinone bis(2-hydroxyethyl) ether (HQEE); 1,3-bis(2-hydroxyethyl) resorcinal (HER); and mixtures thereof.

Suitable amino-terminated chain extenders may be unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-) toluenediamine (i.e., “DETDA”), 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl4,4′-diamino-diphenylmethane (i.e., 4,4′-methylene-bis(2-ethyl-6-methyl-benzeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”); and mixtures thereof. In some embodiments, the amino-terminated chain extender is diethyltoluene diamine. Examples of commercially available diethyltoluene diamines include, but are not limited to, Lonzacure® DETDA 80 LC, available from Arxada of Basel, Switzerland.

Multifunctional and highly branched chain extenders may be used to obtain a hyperbranched structure in the cover composition. In some embodiments, the chain extender is trimethylol propane, glycerol, triglyceride ricinolate, hyperbranched polyol, and combinations thereof.

The cover composition of the present disclosure may include a pigment dispersion. The pigment dispersion may be included in the curative blend with the chain extender. The pigment dispersion may include a pigment and a dispersing agent and may be in a carrier, such as a hydroxy-terminated carrier resin, that is added to the curative blend. Examples of suitable pure pigments include but are not limited to copper pigment, a chromium pigment, an aluminum pigment, a manganese pigment, a gold pigment, an arsenic pigment, a bismuth pigment, a cerium pigment, an iron pigment, a titanium pigment (i.e., titanium oxide of TiO₂), a tin pigment, a zinc pigment, a quinacridone pigment, a phthalocyanine pigment, a complex oxide pigment, an ultramarine violet pigment, a cobalt violet pigment, a manganese violet pigment, a dioxane violet pigment, a quinacridone violet pigment, a carbon black pigment, a white pigment, or combinations thereof. Examples of suitable dispersing agents include fatty acid based wetting agents such as BYK®-W 961; titanate-based additives such as Tytan CP-317; phosphoric acid esters such as Chemphos TC-310S; or any other wetting and dispersing agent. Examples of commercially available pigment dispersions include, but are not limited to, Stan-Tone HCC Vinyl Paste Dispersions, available from Avient Corporation of Avon Lake, Ohio; and Alkyd Dispersion available from Penn Color Inc. of Doylestown, Pennsylvania. In other embodiments, the carrier of the pigment dispersion may be an unreactive plasticizer, and the pigment dispersion may be added to the prepolymer blend or the curative blend.

The pigment dispersion may be included in the cover composition in varying amounts depending on the desired characteristics of the golf ball. In some embodiments, the pigment dispersion may be included in the cover composition in a concentration of about 0.1 percent to about 10.0 percent by weight. In one embodiment, the pigment dispersion is included in the cover composition in a concentration of about 0.1 percent to about 8.0 percent or about 0.01 percent to about 6.0 percent or about 0.01 percent to about 4.0 percent or about 2.0 percent to about 6.0 percent or about 4.0 percent to about 8.0 percent or about 6.0 percent to about 10.0 percent by weight pigment dispersion. In another embodiment, the pigment dispersion is included in the cover composition in a concentration of about 0.1 percent to about 2.0 percent or about 1.0 percent to about 3.0 percent or about 2.0 percent to about 4.0 percent or about 3.0 percent to about 5.0 percent or about 4.0 percent to about 6.0 percent or about 5.0 percent to about 7.0 percent or about 6.0 percent to about 8.0 percent or about 2.0 percent to about 3.0 percent or about 3.0 percent to about 4.0 percent or about 3.5 percent to about 4.5 percent or about 4.0 percent to about 5.0 percent or about 5.0 percent to about 6.0 percent or about 6.0 percent to about 7.0 percent or about 7.0 percent to about 8.0 percent by weight pigment dispersion.

### Forming the Composition

The cover composition may be formed using a one-shot technique or prepolymer technique. In the one-shot technique, the isocyanate-containing component, isocyanate-reactive component, and chain extender are reacted in one step. In the prepolymer technique, the isocyanate-containing component is first reacted with the isocyanate-reactive component to produce a prepolymer. The prepolymer is subsequently and a subsequent reaction between the prepolymer and chain extender forms the cover composition. To form the polyurethane or polyurea prepolymer, the isocyanate-reactive component (i.e., either a hydroxy-terminated component or an amino-terminated component, respectively) is reacted with a stoichiometric excess of the isocyanate-containing component. In some embodiments, the ratio of isocyanate-containing component to isocyanate-reactive component is about 1:0.95 to about 1.2:1. The reaction produces an isocyanate-terminated prepolymer.

As a result of the reaction between the isocyanate compound and polyol or polyamine compounds, there will be some unreacted NCO groups in the prepolymer. The prepolymer should have no greater than about 15%, about 10%, or about 5% unreacted NCO groups based on the total weight of prepolymer. In some embodiments, the prepolymer has no greater than about 12%, about 8%, or about 6% unreacted NCO groups. In other embodiments, the prepolymer has about 1% to about 8% or about 4% to about 7% or about 5% to about 6% unreacted NCO groups based on the total weight of the prepolymer. As the weight percent of unreacted isocyanate groups increases, the hardness of the composition also generally increases.

A prepolymer formed in accordance with the present disclosure may have a lower viscosity than conventional prepolymers used to produce golf ball covers having a reduced hardness. The viscosity of the prepolymer may vary, but in some embodiments, the prepolymer has a viscosity between about 2000 and about 6000 centipoise. In other embodiments, the prepolymer may have a viscosity of about 2000 to about 5000 centipoise or about 3000 to about 6000 centipoise or about 2000 to about 4000 centipoise or about 3000 to about 5000 centipoise or about 4000 to about 6000 centipoise. In still other embodiments, the prepolymer may have a viscosity of about 2000 to about 3000 centipoise or about 2500 to about 3500 centipoise or about 3000 to about 4000 centipoise or about 3500 to about 4500 centipoise or about 4000 to about 5000 centipoise or about 4500 to about 5500 centipoise or about 5000 to about 6000 centipoise.

When the isocyanate-reactive component is hydroxy-terminated, the prepolymer formed includes urethane linkages and is referred to as a polyurethane prepolymer. When the isocyanate-reactive component is amino-terminated, the prepolymer formed includes urea linkages and is referred to as a polyurea prepolymer. On the other hand, when the polyurethane or polyurea prepolymer is reacted with an amino-terminated chain extender or hydroxy-terminated chain extender, respectively, the resulting composition contains urethane and urea linkages and may be referred to as a polyurethane-polyurea or polyurea-polyurethane hybrid or composition, respectively. The concentration of urethane and urea linkages in the hybrid composition may vary. In general, the hybrid composition may contain a mixture of about 10 to 90 percent urethane and about 90 to 10 percent urea linkages. In other embodiments, the cover composition may contain a mixture of about 20 percent to about 80 percent urethane and about 80 to about 20 percent urea linkages. In still other embodiments, the cover composition may contain a mixture of about 30 percent to about 70 percent urethane and about 70 to about 30 percent urea linkages.

In some embodiments, prepolymer's made in accordance with the present disclosure may have a high reactivity with the curative blend while still resulting in a golf ball cover having a reduced hardness. In some embodiments, the reaction between the prepolymer and the curative blend described herein may occur 20% faster than when conventional formulations are used to achieve a golf ball cover having a comparable hardness. For example, a golf ball cover formed using a prepolymer and curative blend of the present disclosure may require 60 seconds for the reaction between the prepolymer and curative blend to complete, while a golf ball cover formed using a conventional prepolymer and curative blend may require 75 seconds for the reaction between the prepolymer and curative blend to complete.

In some embodiments, the base polymer may be included in the cover composition in an amount of about 90 to about 100 percent by weight. In one embodiment, the base polymer is included in the cover composition in an amount of about 90 percent to about 99.9 percent or about 92 percent to about 97 percent or about 90 percent to about 95 percent or about 93 percent to about 95 percent or about 90 percent to about 93 percent or about 92 percent to about 94 percent by weight base polymer. In another embodiment, the base polymer is included in the cover composition in an amount of about 95 percent to about 99.9 percent or about 96 percent to about 99 percent or about 95 percent to about 98 percent or about 97 percent to about 99 percent. In a further embodiment, the base polymer may be included in the cover composition in an amount of about 96 percent to about 99.9 percent or about 97 percent to about 99.9 percent or about 98 percent to about 99.9 percent or about 99 to about 99.9 percent or about 98 to about 99.5 percent or about 98 percent to about 99 percent or about 98.5 to about 99.5 percent base polymer.

### Additives

The cover compositions of the present disclosure may also include fillers, additives, and other ingredients that do not detract from (and possibly enhance) the properties of the final coating composition. These additional materials include, but are not limited to, wetting agents, coloring agents, optical brighteners, hindered amine light stabilizers, rheology modifiers, catalysts, fluorosurfactants, non-fluorescent and fluorescent whitening agents such as titanium dioxide and zinc oxide, ultraviolet (UV) light absorbers, leveling agents, slip agents, processing aids, surfactants, anti-foaming agents, crosslinking agents, and other conventional additives such as antioxidants, stabilizers, softening agents, plasticizers, impact modifiers, foaming agents, density-adjusting fillers, reinforcing materials, compatibilizers, and the like.

In some embodiments, a catalyst is employed to promote the reaction between the isocyanate-containing component and isocyanate-reactive component producing the prepolymer or between prepolymer and chain extender during the chain extending step. Catalysts may be particularly useful when aliphatic isocyanate-containing components are employed and/or the reaction is conducted at a low temperature. In this aspect, suitable catalysts include organic acids such as oleic acid and acetic acid. Amino, organometallic, and delayed catalysts may also be used. Suitable amine catalysts include, but are not limited to, triethylenediamine (TEDA), triethylamine, tributylamine, dimethylethanolamine (DMEA), dimethylcyclohexylamine (DMCHA), and combinations thereof. Suitable organometallic catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis [1-oxonedecyl)oxy]stannane, di-n-octyltin bis-isooctyl mercaptoacetate, and combinations thereof. When used, the catalyst may be added in an amount sufficient to catalyze the reaction of the components in the reactive mixture. In some embodiments, the catalyst is present in an amount from about 0.001 percent to about 1 percent by weight of the reactive mixture. In other embodiments, the catalyst is present in an amount of about 0.1 to about 0.5 percent by weight of the reactive mixture.

### Properties of the Composition

In some aspects, the cover compositions of the present disclosure have a material hardness greater than about 20 Shore D and up to about 70 Shore D (as measured in accordance with ASTM D2240). In some embodiments, a cover formed from the cover compositions of the present disclosure has a material hardness ranging from about 30 Shore D to about 70 Shore D, or from about 35 Shore D to about 65 Shore D, or from about 40 Shore D to about 60 Shore D, or from about 40 Shore D to about 50 Shore D, or from about 25 Shore D to about Shore 70 D, or from about 25 Shore D to about 60 Shore D, or from about 25 Shore D to about 50 Shore D, or from about 25 Shore D to about 40 Shore D, or from about 35 Shore D to about 70 Shore D, or from about 35 Shore D to about 60 Shore D, or from about 35 Shore D to about 50 Shore D, or from about 35 Shore D to about 45 Shore D.

### Cover Component Relationships

In one embodiment, the molecular weight of the first and second isocyanate-containing components and percent of unreacted NCO groups in the prepolymer are related according to the relationship shown in Equation I below:

$$1.3 \leq \frac{{FICC}_{M W} / {SICC}_{M W}}{N C {O}_{U n r e a c t e d}} \leq 100 \qquad ( I )$$

where FICC_{MW} represents the molecular weight of the first isocyanate-containing component in the prepolymer; SICC_{MW} represents the molecular weight of the second isocyanate-containing component in the prepolymer; and NCO_{Unreacted} represents the percent of unreacted NCO groups present in the prepolymer (formatted as a decimal). In another embodiment,

$$3. < \frac{{FICC}_{M W} / {SICC}_{M W}}{{NCO}_{U n r eacted}} < 45.0$$

In still another embodiment,

$$5. < \frac{{FICC}_{M W} / {SICC}_{M W}}{N C {O}_{U n r e a c t e d}} < 2 7.$$

In yet another embodiment,

$$7 \text{.1} < \frac{{FICC}_{M W} / {SICC}_{M W}}{N C {O}_{U n r e a c t e d}} < 20. 0$$

In a further embodiment,

$$10. < \frac{{FICC}_{M W} / {SICC}_{M W}}{N C {O}_{U n r e a c t e d}} < 1 4.$$

### Golf Balls

Golf balls formed in accordance with the present disclosure include at least a core and a cover. Without being bound to any particular theory, golf balls made using the cover compositions of the present disclosure may be softer than conventional golf balls without any sacrifices in processability. In some embodiments, golf balls formed in accordance with the present disclosure have a cover layer formed from a cover composition of the present disclosure.

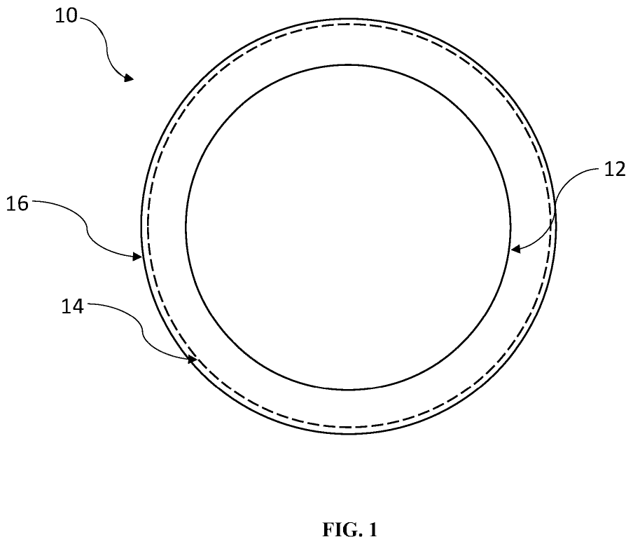

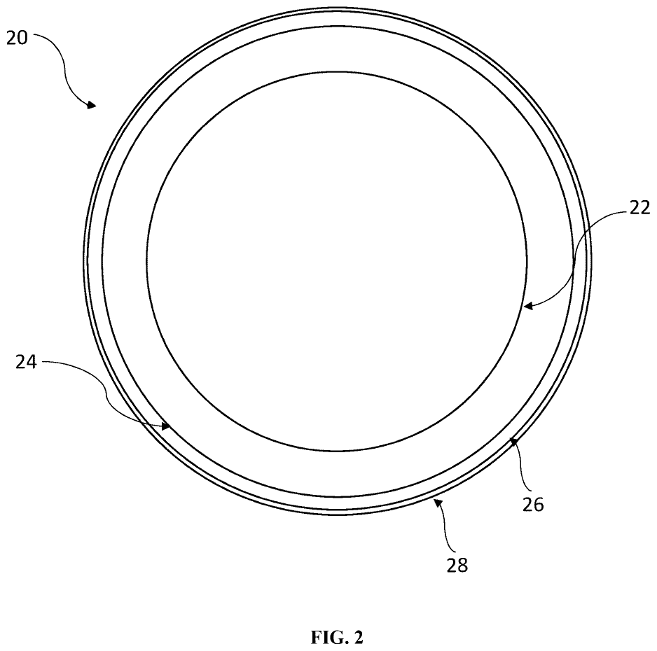

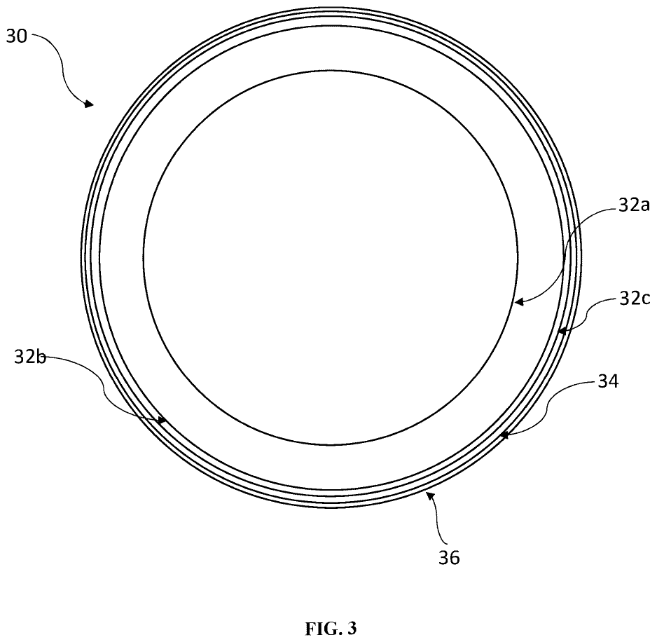

Referring to FIG. 1, in one version, a three-piece golf ball 10 can be made in accordance with the present disclosure. The ball 10 contains a core 12, a cover 16, and a casing layer 14 disposed between the core 12 and the cover 16. Referring to FIG. 2, in one version, a four-piece golf ball 20 can be made in accordance with the present disclosure. The ball 20 contains a center 22, an outer core layer 24, a cover 28, and a casing layer 26 disposed between the outer core layer 24 and the cover 28. Referring to FIG. 3, in another version, a five-piece golf ball 30 contains a core 32 including a center 32a, an outer core layer 32c, and an inner core layer 32b disposed between the center 32a and the outer core layer 32c, a cover 36, and a casing layer 34 disposed between the core 32 and the cover 36. In any of these embodiments, the casing layer 14, 26, and 34 may be considered to be or referred to as an intermediate layer, mantle layer, inner cover layer, or any other layer disposed between the core assemblage and the outer cover of the ball. In any of these embodiments, the cover 16, 28, or 36 may be formed from a cover composition of the present disclosure.

Golf balls made in accordance with the present disclosure can be of any size, although the USGA requires that golf balls used in competition have a diameter of at least 1.68 inches. In accordance with the present disclosure, the weight, diameter, and thickness of the core and cover layers may be adjusted, as needed, so the ball meets USGA specifications of a maximum weight of 1.62 ounces and a minimum diameter of at least 1.68 inches. There is no upper limit so many golf balls have an overall diameter falling within the range of about 1.68 to about 1.80 inches. In this regard, golf balls made in accordance with the present disclosure have a diameter in the range of about 1.68 to about 1.80 inches. In another embodiment, the golf ball diameter is about 1.68 to 1.74 inches. In another embodiment, the golf ball diameter is about 1.68 to 1.70 inches. For play outside of United States Golf Association (USGA) rules, the golf balls can be of a smaller size. In one embodiment, golf balls made in accordance with the present disclosure have a diameter in the range of about 1.68 inches or less, e.g., 1.55 inches to about 1.68 inches.

While the cover compositions discussed above are suitable for use in golf ball cover layers, respectively, it is also contemplated that the cover compositions formed in accordance with the present disclosure may be used to form one or more other layers of any of the one, two, three, four, or five, or more-piece (layered) balls described above. That is, any of the core layers, intermediate layers, and/or cover layers may be formed from the cover compositions of this disclosure.

The core of a golf ball formed in accordance with the present disclosure may be a single-layer core including a solid sphere or a multi-layer core including a center and at least one core layer disposed thereon. Core components may be formed from a rubber formulation, which may also be referred to herein as a core composition. In one embodiment, the rubber formulation includes a base rubber in an amount of about 5 percent to 100 percent by weight based on the total weight of the formulation. In one embodiment, the base rubber is included in the rubber formulation in an amount within a range having a lower limit of about 5 percent or 10 percent or 20 percent or 30 percent or 40 percent or 50 percent and an upper limit of about 55 percent or 60 percent or 70 percent or 80 percent or 90 percent or 95 percent or 100 percent. For example, the base rubber may be present in the rubber formulation in an amount of about 40 percent to about 95 percent by weight based on the total weight of the formulation. In one embodiment, the rubber formulation includes about 55 percent to about 95 percent base rubber based on the total weight of the formulation.

The base rubber may be polybutadiene, polyisoprene, ethylene propylene rubber, ethylene-propylene-diene rubber, styrene-butadiene rubber, styrenic block copolymer rubbers, polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and blends of two or more thereof. In one embodiment, the rubber formulation includes polybutadiene rubber, butyl rubber, or a blend thereof as the base rubber. Examples of commercially available polybutadiene rubbers that can be used as the base rubber in accordance with the present disclosure include, but are not limited to, CB 1221, available from ARLANXEO Performance Polymers of Maastricht, Netherlands. Examples of commercially available styrene-butadiene rubbers that can be used in rubber formulations in accordance with the present disclosure include, but are not limited to, Plioflex® 1502, available from Goodyear, Inc of Akron, Ohio

The rubber formulations further include a reactive crosslinking co-agent. Suitable co-agents include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. In one embodiment, the co-agent is one or more metal salts of acrylates, diacrylates, methacrylates, and dimethacrylates, wherein the metal is selected from magnesium, calcium, zinc, aluminum, lithium, and nickel. In another embodiment, the co-agent includes one or more zinc salts of acrylates, diacrylates, methacrylates, and dimethacrylates. For example, the co-agent may be zinc diacrylate (ZDA). In another embodiment, the co-agent may be zinc dimethacrylate (ZDMA).

The co-agent may be included in the rubber formulation in varying amounts depending on the specific core component for which the rubber formulation is intended. In one embodiment, the amount of co-agent used in the rubber formulations increases for each outer component of the core assemblage. In other words, the co-agent in the rubber formulation for the center is included in a first amount and the co-agent in the rubber formulation for the outer core layer is included in a second amount. The second amount may be more than the first amount. In this aspect, the first amount may be about 25 percent to about 90 percent of the second amount. For example, the first amount may be about 40 percent to about 80 percent of the second amount. In one embodiment, the first amount is about 60 percent to about 75 percent of the second amount.

Radical scavengers such as a halogenated organosulfur, organic disulfide, or inorganic disulfide compounds may also be added to the rubber formulation. In some embodiments, halogenated organosulfur compounds for use in accordance with the present disclosure include, but are not limited to, pentachlorothiophenol (PCTP) and salts of PCTP such as zinc pentachlorothiophenol (ZnPCTP). In another embodiment, ditolyl disulfide, diphenyl disulfide, dixylyl disulfide, 2-nitroresorcinol, and combinations thereof are added to the rubber formulation.

The rubber formulation may also include filler(s). Suitable non-limiting examples of fillers include carbon black, clay and nanoclay particles, talc, glass (e.g., glass flake, milled glass, and microglass), mica and mica-based pigments (e.g., Iriodin® pearl luster pigments from The Merck Group), and combinations thereof. Metal oxide and metal sulfate fillers are also contemplated for inclusion in the rubber formulation. Suitable metal fillers include, for example, particulate, powders, flakes, and fibers of copper, steel, brass, tungsten, titanium, aluminum, magnesium, molybdenum, cobalt, nickel, iron, lead, tin, zinc, barium, bismuth, bronze, silver, gold, and platinum, and alloys and combinations thereof. Suitable metal oxide fillers include, for example, zinc oxide, iron oxide, aluminum oxide, titanium oxide, magnesium oxide, and zirconium oxide. Suitable metal sulfate fillers include, for example, barium sulfate and strontium sulfate. Rubber regrind, which is ground, recycled rubber material obtained from discarded rubber golf ball cores, also can be used as a filler.

When included, the fillers may be in an amount of about 1 to about 40 parts by weight per 100 parts of the total rubber. In one embodiment, the rubber formulation includes at least one filler in an amount of about 1 to about 20 or about 1 to about 15 or about 15 to about 20 parts by weight per 100 parts of the total rubber. In another embodiment, the rubber formulation includes at least one filler in an amount of about 1 to about 10 or about 3 to about 8 or about 4 to about 6 parts by weight per 100 parts of the total rubber. For example, the rubber formulation may include a metal oxide in any of these amounts. In further embodiments, the rubber formulation includes at least one filler in an amount of about 1 to about 30 or about 5 to about 15 or about 10 to about 20 or about 15 to about 25 parts by weight per 100 parts of the total rubber. In yet another embodiment, the rubber formulation includes at least one filler in an amount of about 12 to about 22 or about 15 to about 20 or about 16 to about 18 parts by weight per 100 parts of the total rubber. For example, the rubber formulation may include a metal sulfate in any of these amounts.

Other additives and fillers include but are not limited to optical brighteners, fluorescent agents, whitening agents, UV absorbers, light stabilizers, surfactants, processing aids, antioxidants, stabilizers, softening agents, chemical blowing and foaming agents, defoaming agents, fragrance components, plasticizers, wetting agents, impact modifiers, antiozonants, titanium dioxide, clay, mica, talc, glass flakes, milled glass, coloring agents such as pigments, pigment dispersions, and dyes, and mixtures thereof.

The rubber formulation may be cured using conventional curing processes. Non-limiting examples of curing processes suitable for use in accordance with the present disclosure include peroxide-curing, sulfur-curing, high-energy radiation, and combinations thereof. In one embodiment, the rubber formulation includes a free-radical initiator selected from organic peroxides, high-energy radiation sources capable of generating free-radicals, and combinations thereof. Suitable organic peroxides include, but are not limited to, dicumyl peroxide; n-butyl-4,4-di(t-butylperoxy) valerate; 1,1-di(t-butylperoxy) 3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy) hexyne-3; di(2-t-butyl-peroxyisopropyl)benzene; dilauroyl peroxide; dibenzoyl peroxide; t-butyl hydroperoxide; and combinations thereof. In a particular embodiment, the free radical initiator is dicumyl peroxide, including, but not limited to Perkadox® BC, commercially available from Akzo Nobel. Peroxide free-radical initiators may be present in the rubber formulation in an amount of at least 0.05 parts by weight per 100 parts of the total rubber, or an amount within the range having a lower limit of 0.05 parts or 0.1 parts or 1 part or 1.25 parts or 1.5 parts or 2.5 parts or 5 parts by weight per 100 parts of the total rubbers, and an upper limit of 2.5 parts or 3 parts or 5 parts or 6 parts or 10 parts or 15 parts by weight per 100 parts of the total rubber. Concentrations are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

The core diameter may range from about 1.50 inches to about 1.60 inches. In one embodiment, the core has a diameter of about 1.52 inches to about 1.58 inches. In another embodiment, the core diameter ranges from about 1.52 inches to about 1.56 inches.

When a cover layer of a golf ball formed in accordance with the present disclosure is not formed of a cover composition of the present disclosure, such layer(s) may be formed from a variety of materials including any of the base polymers discussed above in the context of the cover composition, for example, polyurethanes; polyureas; copolymers, blends and hybrids of polyurethane and polyurea; olefin-based copolymer ionomer resins; polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and; crosslinked trans-polyisoprene and blends thereof; polyester-based thermoplastic elastomers; polyurethane-based thermoplastic elastomers; synthetic or natural vulcanized rubber; and combinations thereof.

Likewise, when the layer disposed between the core and the cover (if included) is not formed of a thermoplastic elastomer composition of the present disclosure, conventional and non-conventional materials may be used for forming such layer(s) of the ball including, for instance, ionomer resins, highly neutralized polymers, polybutadiene, butyl rubber, and other rubber-based core formulations, and the like. In this aspect, ionomers suitable for use in accordance with the present disclosure may include partially neutralized ionomers and highly neutralized ionomers (HNPs), including ionomers formed from blends of two or more partially neutralized ionomers, blends of two or more highly neutralized ionomers, and blends of one or more partially neutralized ionomers with one or more highly neutralized ionomers. For purposes of the present disclosure, “HNP” refers to an acid copolymer after at least 70 percent of all acid groups present in the composition are neutralized.

Suitable ionomers may be salts of O/X- and O/X/Y-type acid copolymers, wherein O is an α-olefin, X is a C₃-C₈ α,β-ethylenically unsaturated carboxylic acid, and Y is a softening monomer. O is preferably selected from ethylene and propylene. X may be selected from methacrylic acid, acrylic acid, ethacrylic acid, crotonic acid, and itaconic acid, Y may be selected from (meth)acrylate and alkyl (meth)acrylates wherein the alkyl groups have from 1 to 8 carbon atoms, including, but not limited to, n-butyl (meth)acrylate, isobutyl (meth)acrylate, methyl (meth)acrylate, and ethyl (meth)acrylate. Nonlimiting examples of O/X and O/X/Y-type copolymers include ethylene acid copolymers, such as ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/iso-butyl (meth)acrylate, ethylene/(meth)acrylic acid/methyl (meth)acrylate, ethylene/(meth)acrylic acid/ethyl (meth)acrylate terpolymers, and the like.

“Low acid” and “high acid” ionomeric polymers, as well as blends of such ionomers, may be used. In general, low acid ionomers are considered to be those containing 16 weight percent or less of acid moieties, whereas high acid ionomers (e.g., Surlyn® 8150) are considered to be those containing greater than 16 weight percent of acid moieties. In one embodiment, the inner cover layer is formed from a composition including a high acid ionomer. In another embodiment, the inner cover layer is formed from a composition including a high acid ionomer and a maleic anhydride-grafted non-ionomeric (e.g., Fusabond® 525D (DuPont)). Blends of high acid ionomers with maleic anhydride-grafted polymers are further disclosed, for example, in U.S. Pat. Nos. 6,992,135 and 6,677,401, the entire disclosures of which are hereby incorporated herein by reference.

The layer disposed between the core and the cover (if included) may also be formed from a composition including a 50/45/5 blend of Surlyn® 8940/Surlyn® 9150/Nucrel® 960. In this aspect, the composition may have a material hardness of from 80 to 85 Shore C. In another embodiment, the inner cover layer is formed from a composition including a 50/25/25 blend of Surlyn® 8940/Surlyn® 9150/Surlyn® 9910, having a material hardness of about 85 to 95 Shore C. In yet another embodiment, the inner cover layer is formed from a composition including a 50/50 blend of Surlyn® 8940/Surlyn® 9150, having a material hardness of about 82 to 90 Shore C. A composition including a 50/50 blend of Surlyn® 8150 and Surlyn® 9120 also may be used.

In one embodiment, the golf balls made in accordance with the present disclosure include a core as described herein, a casing layer disposed on the core, and a cover formed from a cover composition of the present disclosure, and the cover has a hardness that is less than that of the casing layer. For example, the casing layer disposed between the core and the cover may have a hardness of greater than about 60 Shore D and the cover may have a hardness of less than about 60 Shore D.

In another embodiment, the cover itself has a hardness of about 60 Shore D or less. In particular, the cover may be from about 30 Shore D to about 70 Shore D. In one embodiment, the cover has a hardness of about 40 Shore D to about 65 Shore D, and in another embodiment, about 40 Shore to about 55 Shore D. In another aspect of the present disclosure, the cover has a hardness less than about 55 Shore D, preferably less than about 50 Shore D, and more preferably about 35 Shore D to about 50 Shore D. In one embodiment, the cover has a hardness from about 40 Shore D to about 50 Shore D.

When a dual cover is disposed about the core, the casing layer may have a thickness of about 0.01 inches to about 0.1 inches, about 0.015 inches to about 0.08 inches, or about 0.02 inches to about 0.05 inches. The cover may have a thickness of about 0.015 inches to about 0.055 inches, about 0.02 inches to about 0.04 inches, or about 0.025 inches to about 0.035 inches.

The core of a golf ball formed in accordance with the present disclosure may have a Coefficient of Restitution (CoR) of at least about 0.760 and more preferably at least about 0.780, about 0.790, or about 0.800. The casing layer of a golf ball formed in accordance with the present disclosure may have a Coefficient of Restitution (CoR) of at least about 0.780 and more preferably at least about 0.800, about 0.810, or about 0.820 Such CoR allows players to generate greater ball velocity off the tee and achieve greater distance with their drives. At the same time, a golf ball including a cover formed from a cover composition of the present disclosure means that a player will have a more comfortable and natural feeling when striking the ball with a club.

The compression of a core made from the rubber formulation of the present disclosure may range from about 20 to about 120 DCM or more preferably about 50 to about 120 DCM. For example, the core compression may be about 50 to about 85 DCM or about 60 to 80 DCM or about 65 to about 75 DCM. In another example, the core compression is about 40 to about 90 DCM or about 50 to about 80 DCM or about 60 to about 70 DCM or about 65 to about 70 DCM. The compression of a casing layer made from the casing composition of the present disclosure range from about 40 to about 140 DCM or about 70 to about 105 DCM or about 80 to 100 DCM or about 85 to about 95 DCM. In another example, the compression of a casing layer is about 60 to about 110 DCM or about 70 to about 100 DCM or about 800 to about 90 DCM or about 85 to about 90 DCM.

The shear durability of a golf ball of the present disclosure, which is manifest as the ability of a golf ball to maintain its mechanical stability and integrity upon the application of shear stress to that golf ball, is preferably comparable to or greater than a golf ball formed with a conventional cover. As shown in Table 1 below, a “shear durability rating” is a qualitative, or relative, scale that incorporates shear mode (i.e., cut/damaged cover, abrasion type damage, and/or paint damage) and severity and weighs them accordingly to make ratings/scores averageable and errors less impactful of overall scores into a scale.

TABLE 1
Shear Durability Rating Scale

| | | Abrasion Type | |
|---|---|---|---|
| Rating | Cut/Damaged Cover | Damage | Paint Damage |
| 1 | Cut or Cracked Cover with | | |
| | casing layer exposed | | |
| 2 | Severe cover damage with | | |
| | multiple groove marks and | | |
| | deep gouges | | |
| 3 | Moderate cover damage | | |
| | with more than one groove | | |
| | mark, missing or severely | | |
| | raised cover material | | |
| 4 | Moderate cover damage | Severe abrasion | |
| | with one larger or several | damage, quarter sized | |
| | smaller groove mark, | are of planed off frets | |
| | raised cover material | with noticeably altered | |
| | | dimples | |
| 5 | Slight cover damage of one | Moderate to severe | |
| | or two groove marks with | abrasion with multiple | |
| | cover that is cut but not | groove marks of | |
| | raised or one or two very | removed fret areas, | |
| | small, raised pieces | slightly noticeable | |
| | | dimple changes | |
| 6 | Very slight cover damage | Moderate abrasion | Severe paint failure with |
| | with one small area of cut | damage. Frets are | missing paint on a quarter |
| | cover, but not raised. Sand | planed off in small | sized area or greater |
| | impregnation | dime sized area or one | |
| | | larger (3-4 dimples | |
| | | long) groove mark | |
| 7 | | Abrasion of a dime | More severe paint damage |
| | | sized area with no | with missing paint on two |
| | | major alteration of fret | or more groove marks |
| | | areas | |
| 8 | | Minor scratches and | Moderate paint damage. |
| | | abrasion of paint and | One to two longer (3-4 |
| | | possible cover | dimples long) groove |
| | | abrasion | marks with interrupted |
| | | | paint or one groove mark |
| | | | with missing paint only |
| 9 | | | Slight paint damage with |
| | | | only one larger or several |
| | | | smaller groove mark of |
| | | | interrupted paint |
| 10 | | | No damage |

In other words, the higher the shear durability rating is, the higher the shear durability of the material. The shear durability rating above can be determined by using a mechanical golf swing machine where one or more hits are made on each of about 6 to 12 substantially identical golf balls of substantially the same composition with either a sand wedge or a pitching wedge. After a suitable calibration procedure, each experimental golf ball may be tested and assigned a rating based on visible manifestations of damage after being struck. The shear durability rating for a golf ball with a particular cover represents a numerical average of all the tested substantially identical golf balls. An alternative way to test the shear resistance of a golf ball cover involves using player testing and evaluating the results after the ball is struck multiple times with wedges or short irons.

Exposing a golf ball to a high moisture environment, such as by soaking the golf ball or storing the golf ball in high humidity for an extended period, may decrease the durability of a golf ball. Accordingly, in some testing procedures, the golf balls may be soaked in water or stored at high humidity for an extended period before testing each golf ball to simulate the durability of the golf ball over an extended period or in extreme conditions.

In one embodiment, a golf ball formed in accordance with the present disclosure, i.e., with a cover formed of a cover composition as disclosed herein, has a shear durability rating of at least 6. In another embodiment, the shear durability of a golf ball formed in accordance with the present disclosure is at least 7. In still another embodiment, a golf ball formed in accordance with the present disclosure, i.e., with a cover formed of a cover composition as disclosed herein, has a shear durability rating of at least 8.

Another commonly used test for measuring shear durability of a golf ball is the repeated ball impact test. The repeated impact test consists of subjecting the finished golf ball to impact repeatedly and visually examining the coating film for peeling from the golf ball. To make the repeated ball impact test reproducible, the test may be carried out using a pneumatic cannon or similar device to propel the balls a 125 feet per second against a rigid wall at an angle of 45 degrees relative to the wall. The ball may be impacted in this manner 100, 200, or 300 or more times depending on the desired level of testing.

When golf balls are formed with the casing and cover compositions of the present disclosure, there are preferably no cracks or crazes after about 100 hits or more. In one embodiment, the casing and cover compositions of the present disclosure prevent cracks or crazes until after about 200 hits or more. In still another embodiment, golf balls formed with the casing and cover compositions of the present disclosure do not have any cracks or crazes until after about 300 hits or more. In yet another embodiment, golf balls formed with the casing and cover compositions of the present disclosure do not have any cracks or crazes until after about 600 hits or more.

In some aspects, the shear durability of a golf ball formed in accordance with the present disclosure i.e., with a cover formed of a cover composition as disclosed herein, is comparable to or better than a golf ball with a conventional cover (holding all of the other ball components constant). In one embodiment, the shear durability of a golf ball formed in accordance with the present disclosure, i.e., with a cover formed of a cover composition as disclosed herein, is about 102 percent or more of the shear durability of a golf ball with a conventional cover (holding all of the other ball components constant). In another embodiment, the shear durability of a golf ball formed in accordance with the present disclosure, i.e., with a cover formed of a cover composition as disclosed herein, is about 105 percent or more of the shear durability of a golf ball with a conventional cover (holding all of the other ball components constant). In still another embodiment, the shear durability of a golf ball formed in accordance with the present disclosure, i.e., with a cover formed of a cover composition as disclosed herein, is about 110 percent or more of the shear durability of a golf ball with a conventional cover (holding all of the other ball components constant).

The golf ball components, such as the cover, formed from the compositions of the present disclosure may provide for golf ball having improved concentricity of the golf ball core within the cover. In this aspect, a golf ball having a cover formed from a cover composition of the present disclosure may allow for better concentricity of the core or cased core within the cover. As will be appreciated by one of ordinary skill in the art of golf ball manufacture (as well as the typical player), the more accurate centering of the core within the golf ball results in more consistent results and an improved game. Without being bound to any particular theory, it is believed that the increased reactivity (i.e., decreased gel time) of the cover compositions of the present disclosure allows for the core to be more concentrically placed within the cover.

In some embodiments, the midpoint of a core formed within a golf ball having a cover formed from the cover composition of the present disclosure is typically no more than about 0.02 inches from the midpoint of the golf ball center. In other words, the core of a golf ball having a cover formed from the cover composition of the present disclosure may be about 0.02 inches or less out of concentricity. In another embodiment, the core of a golf ball having a cover formed from the cover composition of the present disclosure may be about 0.015 inches or less out of concentricity. In still another embodiment, the core of a golf ball having a cover formed from the cover composition of the present disclosure may be about 0.010 inches or less out of concentricity. In yet another embodiment, the core of a golf ball having a cover formed from the cover composition of the present disclosure may be about 0.005 inches or less out of concentricity.

The concentricity measurement may alternatively be expressed as a percentage of center shift relative to the cover thickness. For example, in one embodiment, the core of a golf ball having a cover formed from the cover composition of the present disclosure has a center shift relative to the cover thickness of about 8 percent or less. In another embodiment, the core of a golf ball having a cover formed from the cover composition of the present disclosure has a center shift relative to the cover thickness of about 7 percent or less. In still another embodiment, the core of a golf ball having a cover formed from the cover composition of the present disclosure has a center shift relative to the cover thickness of about 6 percent or less. In yet another embodiment, the core of a golf ball having a cover formed from the cover composition of the present disclosure has a center shift relative to the cover thickness of about 5 percent or less. In still another embodiment, the core of a golf ball having a cover formed from the cover composition of the present disclosure has a center shift relative to the cover thickness of about 4 percent or less. For example, the core of a golf ball having a cover formed from the cover composition of the present disclosure has a center shift relative to the cover thickness of about 3.5 percent or less.

Due to the improved concentricity of the golf ball components in golf balls having covers formed from the cover compositions of the present disclosure, the resulting golf balls also exhibit a number of improved properties. For example, the resulting golf balls exhibit consistent shot dispersion due to the improved concentricity. Shot dispersion refers to the distance the golf ball unintentionally flies to the right or left. The resulting golf balls formed in accordance with the present disclosure may exhibit reduced shot dispersion due to the improved concentricity. Additionally, the resulting golf balls demonstrate improved shear durability. Indeed, golf balls having covers formed from the cover compositions of the present disclosure may be significantly more durable than golf balls with covers formed from traditional cover compositions as discussed above.

The golf balls of the present disclosure may be formed using a variety of application techniques. For example, the golf ball layers may be formed using compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials. In this aspect, cover layers may be formed over the core assemblage using any suitable technique that is associated with the material used to form the layer. For example, the cover compositions of the present disclosure may be formed into one or more layers of a golf ball using casting or injection molding techniques.

The golf ball components, such as the cover, formed from the compositions of the present disclosure may provide for golf balls having covers with fewer blemishes even without undergoing post cure steps. In some embodiments, no post cure steps were needed to produce blemish free covers. Without being bound to any particular theory, it is believed that the increased reactivity (i.e., decreased gel time) of the cover compositions of the present disclosure reduces the frequency of blemishes without the need for post cure steps.

Golf balls made in accordance with the present disclosure may be subjected to finishing steps such as flash-trimming, surface treatment (such as buffing of the parting line and surface preparation via vibratory media tumble), marking, coating, and the like using techniques known in the art. In one embodiment, a white-pigmented cover may be surface-treated using a suitable method such as, for example, corona, plasma, or ultraviolet (UV) light treatment. Indicia such as trademarks, symbols, logos, letters, and the like may be printed on the cover using pad printing, ink-jet printing, dye-sublimation, or other suitable printing methods. Clear surface coatings (for example, primer and top coats), which may contain a fluorescent whitening agent, may be applied to the cover. Golf balls may also be painted with one or more paint coatings in a variety of colors. In one embodiment, white primer paint is applied first to the surface of the ball and then a white topcoat of paint may be applied over the primer.

### EXAMPLES

The invention is further illustrated by the following examples. It should be understood that the examples below are for illustrative purposes only. These examples should not be construed as limiting the scope of the present disclosure.

### Example 1

The following example compares golf balls having a core, a casing layer disposed about the core, and a cover layer disposed about the casing layer. Particularly, Table 1 below compares three golf balls: a control, golf ball A, and golf ball B. The control golf ball is a golf ball formed using components have conventional compositions. Golf ball A is a golf ball formed using a cover formed from a composition having a decreased content of the isocyanate-containing component in the prepolymer. Golf ball A represents the traditional method used to produce golf ball covers having a low hardness by reducing the content of the isocyanate-containing component in the prepolymer. Golf ball B is a golf ball including a cover formed from a composition in accordance with the present disclosure. Table 1 provides details on the construction of the three golf balls, the properties of the cover layers of such golf balls, and the performance characteristics of the golf balls.

Each of the golf balls shown in Table 1 below include cover compositions having a polyurethane base polymer formed from a polyurethane prepolymer and polyurea curative blend. In the control golf ball and golf ball A, the polyurethane prepolymers includes a blend of isocyanate-containing components, Desmodur® W and Desmodur® N-3400. In contrast, the polyurethane prepolymer of golf ball B was formed using a blend of isocyanate-containing components including isophorone diisocyanate (IPDI) and Desmodur® N-3400, in accordance with the present disclosure. The prepolymers of each golf ball included a single isocyanate-reactive component, PTMEG 2000 (polytetramethylene ether glycol 2000). The prepolymers of each of the golf balls were prepared with a stoichiometric excess of the isocyanate-containing components such that the prepolymer of the control golf ball had 5.5% unreacted NCO groups whereas the prepolymer of golf balls A and B had 5.0% unreacted NCO groups. The polyurea curative blends for all compositions shown include an amino-terminated chain extender, Lonzacure® DETDA 80 LC (diethyltoluene diamine) and a catalyst, acetic acid.

TABLE 4
Properties of Prepolymers and Covers Formed from Such Prepolymers

| | Golf Ball | Control | A | | B | |
|---|---|---|---|---|---|---|
| Cover | Isocyanate-Containing Component | 70/30 | 70/30 | | 70/30 | |
| Compositi | | W/N-3400 | W/N-3400 | | IPDI/N-3400 | |
| | % Unreacted NCO Groups | 5.5 | 5.0 | | 5.0 | |
| | Isocyanate-Reactive Component | PTMEG 2000 | | | | |
| | Curative Blend | Lonzacure ® DETDA 80 LC with acetic acid | | | | |
| Core | Core Type | Polybutadiene core with ionomer casing | | | | |
| Cover | Gel Time | 80 | 82 | | 74 | |
| Properties | Material Shore D Hardness | 46 | 45 | | 42 | |
| | Wet Shear Rating | 5.9 | 8.6 | | 8.5 | |
| | Dry Shear Rating | 7.1 | 8.5 | | 8.2 | |
| | Concentricity of Cased Core | Typical | Typical | | No Visible | |
| | Within Cover | Shifting | Shifting | | Shifting | |
| Spin | 130 Driver (Δ Spin vs Control) | 3145 | 3148 | (+3) | 3441 | (+296) |
| Rate | 150 Driver (Δ Spin vs Control) | 3112 | 3171 | (+59) | 3293 | (+181) |
| | 182-2700 Driver (Δ Spin vs Control) | 2766 | 2789 | (+23) | 2962 | (+196) |
| | Hybrid 17° (Δ Spin vs Control) | 4402 | 4486 | (+84) | 4715 | (+313) |
| | 5 Iron (Δ Spin vs Control) | 5665 | 5920 | (+255) | 5928 | (+263) |
| | 8 Iron (Δ Spin vs Control) | 8465 | 8578 | (+113) | 8813 | (+348) |
| | Full Wedge (Δ Spin vs Control) | 10022 | 10308 | (+286) | 10363 | (+341) |
| | Half Wedge (Δ Spin vs Control) | 7291 | 7310 | (+19) | 7941 | (+200) |

As shown in Table 1, a comparison of the control golf ball and golf ball A demonstrates the modest effectiveness that decreasing the content of the isocyanate-containing component in the prepolymer has on the hardness of the resulting golf ball cover. A reduction in unreacted NCO groups, which is a proxy for the relative content of the isocyanate-containing component used in the prepolymer, from 5.5% in the control ball to 5.0% in golf ball A resulted in a decrease in hardness from 46 Shore D to 45 Shore D. This decrease in the hardness of the cover between the control golf ball and golf ball A resulted in a moderate increase in the spin rate of golf ball A as compared to the control golf ball. This effect on spin rate was more pronounced when a higher lofted club (e.g., 5 Iron, 8 Iron, Full Wedge) is used. However, the decrease in cover hardness and resulting increase in spin rate from the control golf ball to golf ball A was accompanied by an increase in gel time of the cover composition, and both the control golf ball and golf ball A exhibited shifting of the cased core within the cover.

In contrast, a comparison of golf ball B with golf ball A and the control golf ball demonstrates the superior effectiveness that using the blend of IPDI and Desmodur® N-3400 as the isocyanate-containing component has on the hardness of the resulting golf ball cover. For example, a comparison of golf ball B, which used the blend of IPDI and Desmodur® N-3400 as the isocyanate-containing component, with golf ball A, which used a blend of Desmodur® W-3400 and Desmodur® N-3400 as the isocyanate-containing component, shows that replacing Desmodur® W-3400 with IPDI results in a decrease of in hardness from 45 Shore D to 42 Shore D. This is an additional 300% decrease in hardness as compared to the decrease in hardness of the golf ball cover resulting from reducing the unreacted NCO groups in the prepolymer from 5.5% (as in the control golf ball) to 5.0% in golf ball A. The decrease in the hardness of the cover of golf ball A as compared to the cover of the control golf ball results in a significant increase in the spin rate across all clubs tested. The additional decrease in hardness of the cover of golf ball B as compared to the cover of golf ball A resulted in a notable increase in the spin rate of golf ball B as compared to golf ball A. The increase in spin rate from golf ball A to golf ball B was most pronounced when a lower lofted club (130 Driver, 150 Driver, 182-2700 Driver, Hybrid 17°) was used. Moreover, the decrease in cover hardness and resulting increase in spin rate in golf ball B was accompanied by a decrease in gel time as compared to the control golf ball and in contrast to golf ball A, which exhibited an increase in gel time as compared to the control golf ball. The decrease in gel time in golf ball B was sufficient to eliminate any visible shifting of the cased core within the cover.

### Example 2

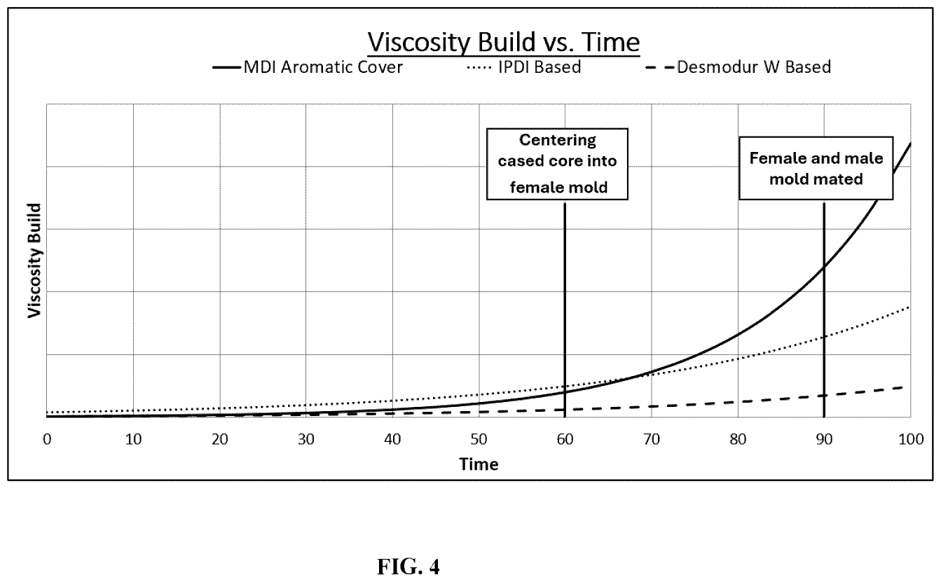

FIG. 4 provides a graph showing the viscosity build of three cover compositions over 100 seconds after the prepolymer is mixed with the curative blend. Each of the cover compositions is identical except that the first uses an aromatic MDI as the isocyanate-containing component, the second uses a 70/30 blend of IPDI and Desmodur® N-3400 as the isocyanate-containing component, and the third uses a 70/30 blend of Desmodur® W and Desmodur® N-3400 as the isocyanate-containing component.

The viscosity build of each composition is representative of the reaction rate between the prepolymer and the curative blend of the compositions. As shown in FIG. 4, the three compositions start at approximately the same viscosity build at time 0 when the prepolymer is mixed with the curative blend. The viscosity build of the composition including Desmodur® W as an isocyanate-containing component stays lower than the other two compositions over the course of the 100 seconds of the experiment. The viscosity build of the composition using an aromatic MDI as the isocyanate-containing component increases slow at first but rapidly increases after about 70 seconds to result in the highest final viscosity build. The viscosity build of the composition using IPDI as an isocyanate-containing component begins higher than the other two compositions and continues to be higher through about 65 seconds, which is after the cased core is centered into the female mold. Although the viscosity build of the composition using IPDI as an isocyanate-containing component increases at a lower rate than the viscosity build of the composition using an aromatic MDI as the isocyanate-containing component after about 65 seconds, the higher viscosity build and, in turn the reaction rate, of the composition using IPDI as an isocyanate-containing component earlier in the molding process from 0 to 60 seconds reduces cover blemishes and manufacturing complexity.

### Example 3

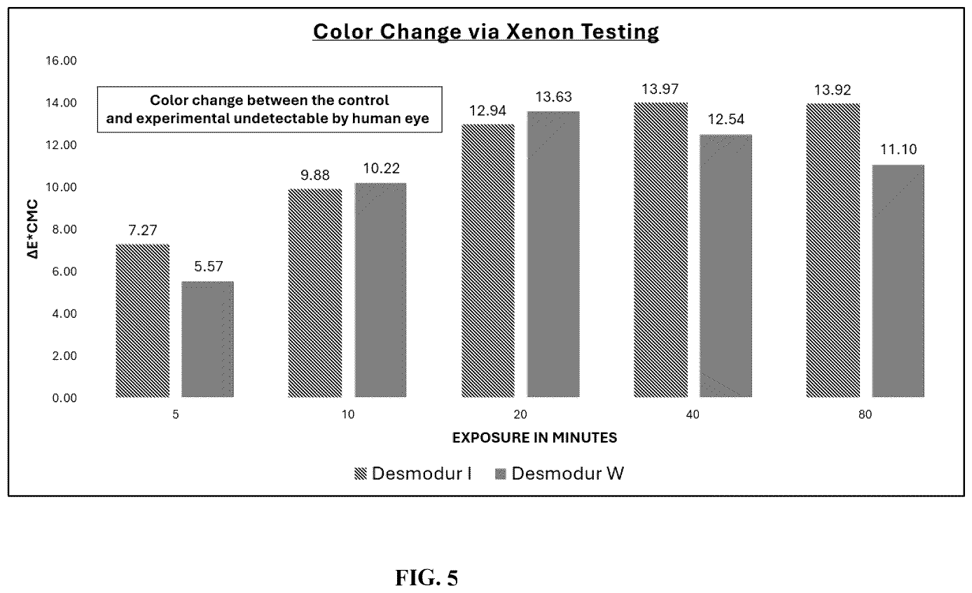

FIG. 5 provides a graph illustrating the difference in color change of golf ball covers as measured using xenon testing. Xenon testing, also known as xenon arc testing, is a method of accelerated weathering that simulates the effects of natural weathering, including UV radiation, heat, and moisture, to assess the durability and longevity of materials. The vertical axis of the graph shown in FIG. 5 represents the difference in color change between the golf ball covers being tested and a control golf ball cover formed using conventional materials. The cover compositions of the first experimental golf ball and second experimental golf ball were identical except that the first experimental golf ball cover was formed using a prepolymer formed using Desmodur® I (IPDI) as an isocyanate-containing component while the second experimental golf ball cover was formed using a prepolymer containing Desmodur® W. The horizontal axis represents the exposure of the golf balls being tested to xenon testing in minutes. As shown in FIG. 5, the difference in color change between the golf ball covers being tested and the control golf ball cover is less than fourteen through the course of testing, which is a difference that is undetectable to the human eye. The color change of the golf ball cover formed using Desmodur® I was more than the color change of the golf ball cover formed using Desmodur® W when measured at five minutes but slightly less when measured at ten and twenty minutes. The color change of the golf ball cover formed using Desmodur® I then increase to slightly more than the color change of the golf ball cover formed using Desmodur® W when measured at 40 minutes and 80 minutes. Overall, there is not a significant difference between in the color stability of the golf ball cover formed using Desmodur® I and the golf ball cover formed using Desmodur® W.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well-known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well (i.e., at least one of whatever the article modifies), unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The golf balls described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the device in addition to those shown and described herein will become apparent to those skilled in the art from the foregoing description. Such modifications are also intended to fall within the scope of the appended claims. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. A golf ball, comprising:
a core; and
a cover disposed on the core and formed from a cover composition, wherein the cover composition comprises a reaction product of:
a first isocyanate-containing component comprising isophorone diisocyanate;
a second isocyanate-containing component having a molecular weight that is about 200 to about 600 g/mol;
an isocyanate-reactive component; and
a chain extender.

2. The golf ball of claim 1, wherein the second isocyanate-containing component is aliphatic.

3. The golf ball of claim 2, wherein the second isocyanate-containing component comprises 1,6-hexamethylene diisocyanate (HDI).

4. The golf ball of claim 3, wherein the second isocyanate-containing component comprises HDI uretdione and HDI isocyanurate.

5. The golf ball of claim 1, wherein the ratio of the first isocyanate-containing component to the second isocyanate-containing component ranges from about 50:50 to about 90:10.

6. The golf ball of claim 5, wherein the ratio of the first isocyanate-containing component to the second isocyanate-containing component ranges from about 60:40 to about 80:20.

7. The golf ball of claim 1, wherein the isocyanate-reactive component comprises polyether polyol.

8. The golf ball of claim 7, wherein the isocyanate-reactive component comprises polytetramethylene ether glycol.

9. The golf ball of claim 1, wherein the chain extender is a hydroxy-terminated chain extender.

10. The golf ball of claim 1, wherein the chain extender is an amino-terminated chain extender.

11. The golf ball of claim 1, wherein the ratio of the first and second isocyanate-containing components to the isocyanate-reactive component is about 1:0.95 to about 1.2:1.

12. A golf ball, comprising:
a core; and
a cover disposed on the core and formed from a cover composition, wherein the cover composition comprises a reaction product of:
a first isocyanate-containing component comprising isophorone diisocyanate;
a second isocyanate-containing component comprising 1,6-hexamethylene diisocyanate (HDI);
an isocyanate-reactive component; and
a chain extender,
wherein the ratio of the first isocyanate-containing component to the second isocyanate-containing component ranges from about 50:50 to about 90:10.

13. The golf ball of claim 12, wherein the ratio of the first isocyanate-containing component to the second isocyanate-containing component ranges from about 60:40 to about 80:20.

14. The golf ball of claim 12, wherein the second isocyanate-containing component comprises HDI uretdione and HDI isocyanurate.

15. The golf ball of claim 12, wherein the ratio of the first and second isocyanate-containing components to the isocyanate-reactive component is about 1:0.95 to about 1.2:1.

16. A golf ball, comprising:
a core; and
a cover disposed on the core and formed from a prepolymer and a chain extender,
wherein the prepolymer comprises the reaction product of a first isocyanate-containing component having a first molecular weight FICC_{MW}, a second isocyanate-containing component having a second molecular weight SICC_{MW}, and an isocyanate-reactive component,
wherein after the reaction of the first isocyanate-containing component, the second isocyanate containing component, and the isocyanate reactive component, the prepolymer has a percentage of unreacted NCO groups NCO_{Unreacted}, and wherein
$$1.3 \leq \frac{{FICC}_{M W} / {SICC}_{M W}}{N C {O}_{U n r e a c t e d}} \leq 100 .$$

17. The golf ball of claim 16, wherein
$$5. < \frac{{FICC}_{M W} / {SICC}_{M W}}{N C {O}_{U n r e a c t e d}} < 27. .$$

18. The golf ball of claim 16, wherein
$$10. < \frac{{FICC}_{M W} / {SICC}_{M W}}{N C {O}_{U n r e a c t e d}} < 14. .$$

19. The golf ball of claim 16, wherein NCO_{Unreacted} is equal to about 1% to about 8% based on the total weight of the prepolymer.

20. The golf ball of claim 16, wherein NCO_{Unreacted} is equal to about 5% to about 6% based on the total weight of the prepolymer.
